(19) United States
(12) Patent Application Publication
(10) Pub. No.: US 2006/0012823 A1
(43) Pub. Date: Jan. 19, 2006

(54) Image forming apparatus, control method, control program, job managing apparatus, job processing method, and job managing program

(75) Inventor: Hiroki Fukuda, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/176,385

(22) Filed: Jul. 8, 2005

(30) Foreign Application Priority Data
Jul. 16, 2004 (JP) 2004-210112

(51) Int. Cl. G06F 15/00

(52) U.S. Cl. 358/1.15

(57) ABSTRACT

There is disclosed a job information processing method having, for example: a managing step of managing job information and a job information accounting table including statistic data of job information obtained by collecting the job information; an obtaining step of obtaining output setting information which defines an outputting method of the job information from an external information processing apparatus through a communicating medium; and a transmitting step of transmitting the job information to the external information processing apparatus or another information processing apparatus in accordance with the output setting information obtained in the obtaining step.

### BACKGROUND OF THE INVENTION

1. Field of the Invention

The present invention generally relates to an image forming apparatus including a printer, a scanner, a facsimile, a copying apparatus, and the like, and an apparatus having functions of a hybrid apparatus of them as examples and also relates to a control method, a control program, a job managing apparatus, a job processing method, and a job managing program of such an apparatus.

2. Related Background Art

Hitherto, there has been known a job managing apparatus for managing jobs when the user uses a peripheral apparatus such as printer (printing apparatus), scanner, copying apparatus, multifunction apparatus (MFP) obtained by integrating them, or the like through a network. Among such information processing apparatuses, an apparatus having a function of outputting a history of the job to a file has been known. Such a job managing apparatus manages the job history by collecting job information outputted to a plurality of multifunction apparatuses (MFPs) to one information. To execute such a collecting process, it is general to prepare an information processing apparatus (computer) for executing a job managing process (refer to Japanese Patent Application Laid-Open No. 2003-308191).

In image forming apparatuses such as printer, scanner, facsimile, copying apparatus, apparatus having hybrid functions of them, and the like, there has been used a method whereby on an OS to be implemented in a system, another execution environment to be implemented in the system, for example, an execution environment such as “Java (registered trademark)” or the like is constructed and an application module is downloaded and installed (refer to Japanese Patent Application Laid-Open No. 2003-330732).

### SUMMARY OF THE INVENTION

Although the job information is collected in the image forming apparatuses such as multifunction printer (MFP), printer, scanner, copying apparatus, and the like, there is such a problem that the job information cannot be held because of a limitation of a memory amount. There is also a method of collecting a part of the job information and holding only a collection result as an accounting table. However, if the job information is collected as an accounting table, there is such a problem that detailed information included in the job information cannot be collected in an on-demand manner when it is necessary to collect the jobs as detailed information.

Further, although collection of the job information by an apparatus having a predetermined server function is presumed, a mechanism for transmitting outputting methods of the job information from the image forming apparatus to the apparatus having the server function becomes further another problem. For example, it is necessary that at least one of the outputting methods of the job information about when, to which output destination, and by which communicating protocol the job is outputted is set to a plurality of image forming apparatuses. There is, consequently, such a problem that execution of such a setting process to all of the image forming apparatuses visiting them one by one heavily burdens the IT manager.

The invention is made to solve at least one of the above problems. As a preferred aspect of the invention, there is provided an image forming apparatus comprising: a managing unit adapted to manage job information and a job information accounting table including statistic data of job information obtained by collecting the job information; an obtaining unit adapted to obtain output setting information which defines an outputting method of the job information from an external information processing apparatus through a communicating medium; and a transmitting unit adapted to transmit the job information to the external information processing apparatus or another information processing apparatus in accordance with the output setting information obtained by the obtaining unit. A method and a control program which can be applied to such an image forming apparatus are also disclosed.

As another preferred aspect of the invention, there is provided a job managing apparatus for managing job information which is stored in an image forming apparatus which manages a job information accounting table and the job information, comprising: a managing unit adapted to manage the job information as defined output setting information in which an outputting method of the job information including time information indicative of time when the image forming apparatus outputs the job information or information indicative of an output destination to which the job information is outputted has been defined; and a transmitting unit adapted to transmit the output setting information which is managed by said managing unit to a plurality of image forming apparatuses. A method and a control program which can be applied to such an image forming apparatus are also disclosed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a construction of an MFP 1102 as an example of image forming apparatuses according to the invention;

FIG. 2 is a diagram showing an internal construction of a setting PC 1101, which will be explained hereinafter;

FIG. 3 is a diagram showing an example of a structural diagram of software which is realized in an MFP 1102;

FIG. 4 is a block diagram of a setting application of the setting PC 1101 and a job managing application which is executed in the second execution environment of the image forming apparatuses;

FIG. 5 shows a job history which is formed by a job managing application 1105 of the MFP 1102 in FIG. 4;

FIG. 6 is a job information accounting table which is formed by the job managing application 1105 in FIG. 4;

FIG. 7 is a diagram showing processing contents of the job managing application 1105 in FIG. 4;

FIG. 8 is a diagram showing contents of an output log collecting process in the job managing application 1105 in FIG. 4;

FIG. 9 is a diagram showing processing contents in the case where a menu selection is executed in the job managing application 1105;

FIG. 10 is a diagram showing processing contents in the case where the job managing application receives job history output information set by a job management setting application;

FIG. 11 is a diagram showing contents of a process which is executed in the case where execution timing of a schedule of a job history output has reached the appointed time in the job managing application 1105; and

FIG. 12 is a diagram showing a display screen of a job history output setting in the job managing application.

### DETAILED DESCRIPTION OF THE PREFERRED EMBODIMENTS

Embodiments of the present invention will now be described in detail in accordance with the accompanying drawings.

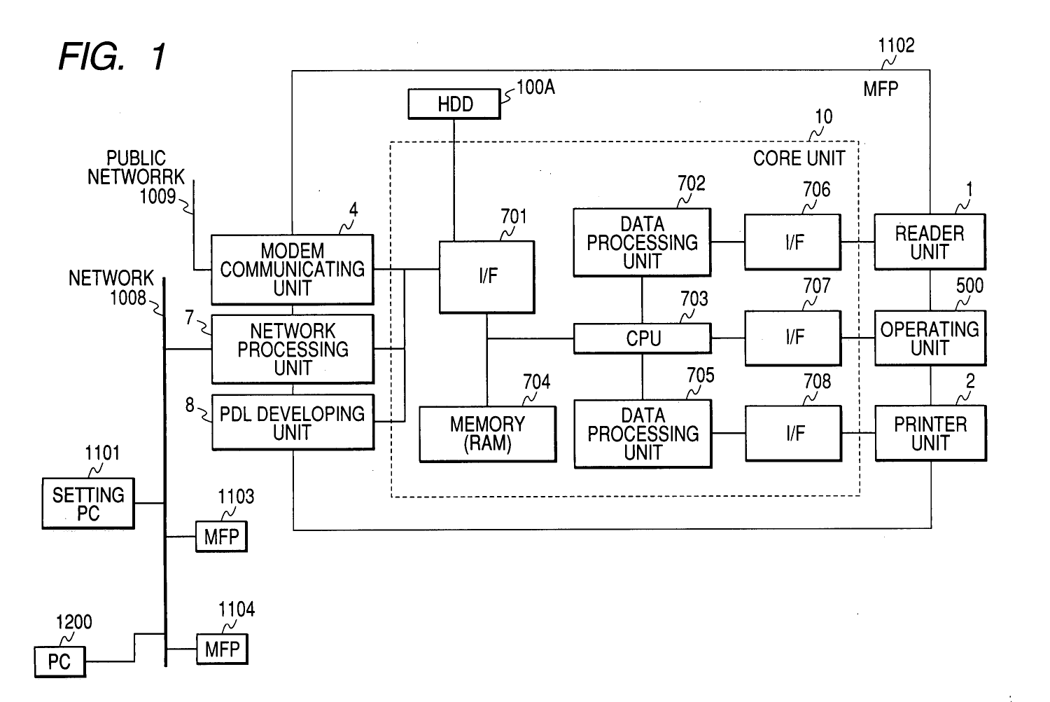

FIG. 1 is a block diagram showing a construction of an MFP 1102 as an example of image forming apparatuses according to the invention. Each of MFPs 1103 and 1104 has a construction similar to that of the MFP 1102. A core unit 10 has: interface units 701, 706, 707, and 708; data processing units 702 and 705; a CPU 703 (each control means); and a memory 704 (storing means).

The construction will be described in detail. The image data from a reader unit 1 is transmitted to the data processing unit 702 through the I/F 706. The data processing unit 702 executes an image process such as rotating process, zooming process, or the like of an image. Image data transmitted to the data processing unit 702 is accumulated as digital image data into the memory 704 through the CPU 703. The digital image data is transmitted to a printer unit 2 through the CPU 703, the data processing unit 705, and the I/F 708 in response to a control command from an operating unit 500 as a preferred example of a display unit of the invention or transmitted to a modem communication processing unit 4 and a network processing unit 7 through the interface unit 701. The operating unit 500 is constructed by using, for example, a liquid crystal panel. The liquid crystal panel has a function of a touch pad and when a finger is touched to the panel, a key corresponding to a predetermined command or setting can be selected.

Code data indicative of the image inputted through the network processing unit 7 is transmitted to the CPU 703 through the I/F 701. When the CPU determines that the code data is a PDL code, the PDL code is transmitted to a PDL developing unit 8 through the I/F 701 and developed into image bit map data. The image bit map data is accumulated into the memory 704 through the I/F 701 and the CPU 703. After that, it is transmitted to the printer unit 2 through the CPU 703, the data processing unit 705, and the I/F 708 and printed.

After FAX image data from the modem communication processing unit 4 is transmitted to the data processing unit 705 through the I/F 701 and the CPU 703, it is transmitted to the printer through the I/F 708.

The CPU 703 makes the control as mentioned above in accordance with a control program stored in the memory 704 and a control command received from the operating unit 500 via the I/F 707. The memory 704 is also used as a work area of the CPU 703.

As mentioned above, in the image forming apparatus, processes of multifunctions such as reading of the original image, printing of the image, transmission and reception of the image, storage of the image, input/output of the data to/from a computer, and the like can be executed mainly by the core unit 10 of an image input/output control unit 3. The interface unit (I/F unit) 701 as a preferred example of input means of the invention can download various applications and control programs from a server or another image forming apparatus on an external network and store them into the memory 704. A detachable memory slot (not shown) can be considered as another preferred example of the input means. The programs can be also downloaded and stored into the memory 704 not only from the network but also from a portable storing medium such as flexible disk, IC card, DVD, CD-ROM, or the like connected to the memory slot. The network processing unit 7 is connected to a network 1008 and controls transmitting and receiving processes of the data. The MFPs 1103 and 1104 are also connected to the network 1008 and a setting PC 1101 is further connected thereto. As will be explained hereinafter, the setting PC 1101 can communicate with each of the MFPs 1102 to 1104 through the network 1008 and set an outputting method of job information.

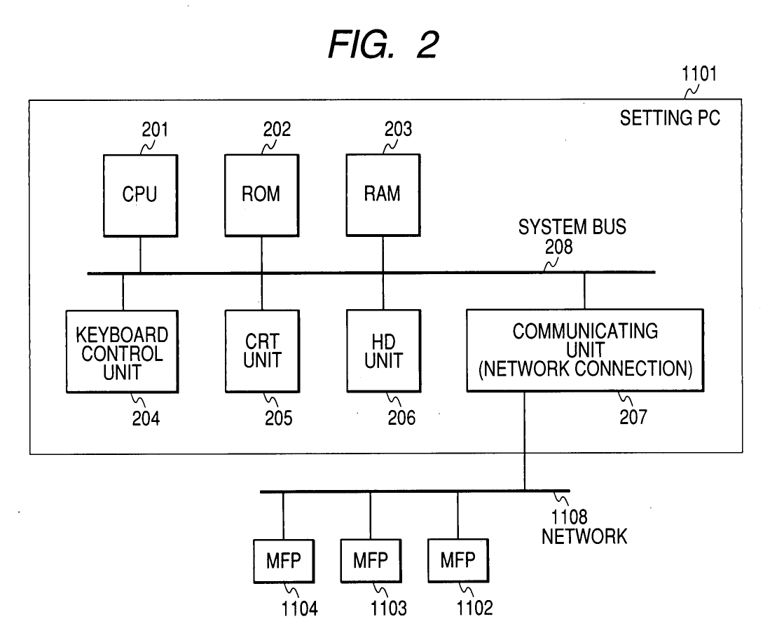

FIG. 2 is a diagram showing an internal construction of the setting PC (personal computer) 1101, which will be explained hereinafter. In FIG. 2, reference numeral 201 denotes a CPU, that is, a central processing unit for controlling the whole computer apparatus and executing an arithmetic operating process or the like. The setting PC 1101 communicates with the MFPs 1102 to 1104 through the network 1008 by using a communicating unit 207 and sets an output setting method of the job. Such a process will be explained hereinafter. Reference numeral 202 denotes a ROM, that is, read only memory as a storing area of information or the like of a system activating program. Reference numeral 203 denotes a RAM, that is, random access memory as a data storing area without use limitation. The RAM 203 is an area where programs for an operating system, applications, device drivers, communication control, and the like are controlled, loaded, and executed by the CPU 201.

Reference numeral 204 denotes a KBC, that is, a keyboard control unit for receiving input data from a keyboard and transferring it to the CPU. Reference numeral 205 denotes a CRT as an example of display means, that is, a display control unit for controlling a display to a display apparatus. Reference numeral 206 denotes an HD as an example of storing means, that is, a hard disk device for storing the programs and the data. The stored programs and data are referred to or loaded into the RAM as necessary upon execution. An FD, that is, a floppy (registered trademark) disk device, an SRAM, that is, nonvolatile storing device, or the like can be also provided in place of the HD 206.

Reference numeral 207 denotes the communicating unit for making network communication control. The communicating unit 207 can communicate with another computer or peripheral device connected to the network as described in FIG. 1. Reference numeral 208 denotes a system bus serving as a path of the data among the above component elements.

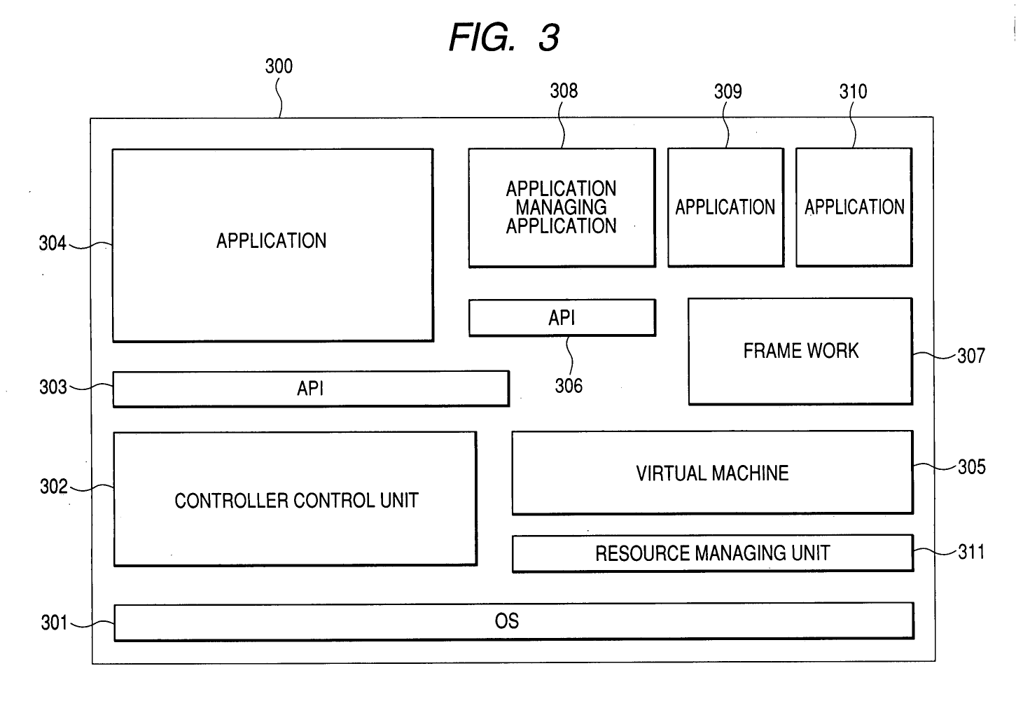

FIG. 3 is a diagram showing an example of a structural diagram of software which is realized in the MFP 1102 as an example of the image forming apparatus of the invention. Each of MFPs 1103 and 1104 is also constructed in a manner similar to that of the MFP 1102. FIG. 3 shows an example of functional modules of software. Those functional modules are stored as control programs in an HDD 100A in FIG. 1, developed in the memory (RAM) 704, read out therefrom, and executed under control of the CPU 703.

Reference numeral 301 denotes an example of a first execution environment of the invention for controlling the whole image forming apparatus. Generally, the first execution environment 301 is each module of the real-time OS which can control various functions of a copying apparatus in a real-time manner or a library group which can critically control each function including an optional apparatuses and an expansion card of the copying apparatus by instructing the CPU. The first execution environment 301 is realized by a module group which provides interface commands to an application which operates in an upper position. Reference numeral 302 denotes a controller control unit which operates on the first execution environment 301. It is assumed that the controller control unit 302 is constructed by modules for controlling the reader unit 1, printer unit 2, modem communication processing unit 4, PDL developing unit 8, and the like.

Reference numeral 303 denotes an application programming interface (hereinbelow, abbreviated to “API”) having a processing function to access the controller control unit 302 by this interface in response to a command train of an input of commands from the application and a function for sending a control command to a hybrid apparatus or the like through the network processing unit 7 and the network 1008. Reference numeral 304 denotes an application which operates on the first execution environment 301. The application 304 makes a request to the controller control unit 302 for various processes by using the API 303. It is also possible to drive the network processing unit and the I/F unit 701 in FIG. 1 by using the network processing unit 7 and communicate with another computer on the network 1008 or the MFPs 1102 to 1104, and the like.

Reference numeral 305 denotes a second execution environment which is optimum to execute a specific application. The second execution environment 305 is realized, for example, by a virtual machine or the like of Java (registered trademark). Reference numeral 306 denotes an API for allowing the application on the second execution environment 305 of the invention to access the controller control unit 302 which operates on the real-time OS 301 as a first execution environment. In the embodiment, the API 306 has a function of a converting module for calling the API 303 and a function of sending the control command to the image forming apparatus or the like through the network processing unit 7 and the network 1008.

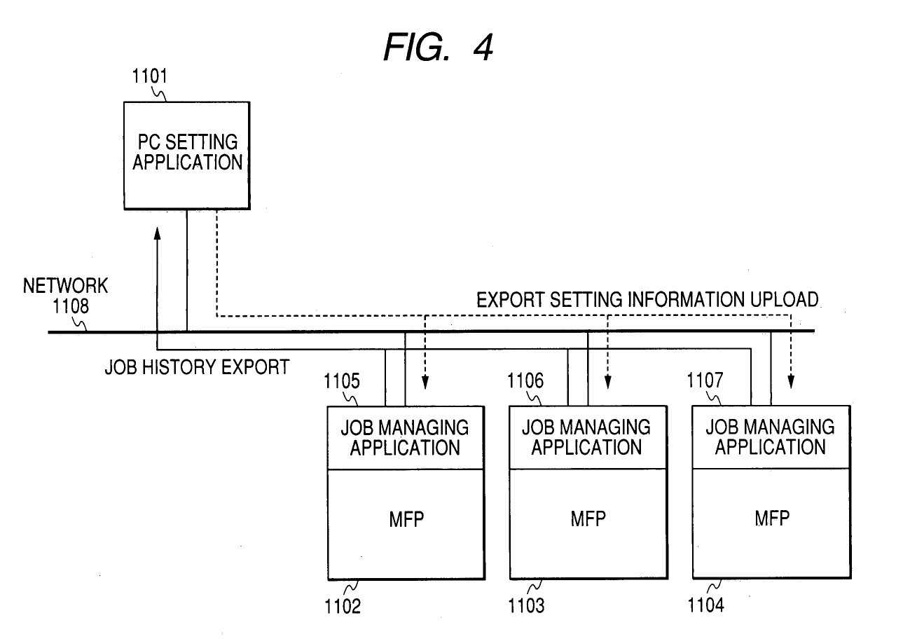

Reference numeral 307 denotes a framework module having a function for integratedly controlling the applications on the second execution environment 305. Reference numeral 308 denotes an application for managing other applications on the second execution environment 305 of the invention. The application 308 executes downloading, uploading, erasure, or invalidation of applications 309 and 310, which will be explained hereinafter, in cooperation with the framework module 307. As an application 309, in the embodiment, job managing applications 1105 to 1107 in FIG. 4 are applications which operate on the second execution environment 305 and are also applications for making a request to the controller control unit 302 for various processes by using the API 306 or constructing a job information accounting table by collecting the job information. It is also possible to communicate with an application on another apparatus through the network.

Reference numeral 311 denotes a resource managing unit for managing resources which are used by the second execution environment 305 of the invention. The resource managing unit 311 operates on the real-time OS 301 which realizes the first execution environment. The resource managing unit 311 restricts so that the resources of a predetermined amount or more cannot be used when the virtual machine 305 itself which realize the second execution environment, API 306, and framework module 307 or all applications on the OS 305 use the resources such as a memory or the like.

First, the API 303 will be described. The API 303 is a set of interfaces on the real-time OS 301 corresponding to a plurality of control commands for accessing the controller control unit 302 which is controlled by the real-time OS 301 as a first execution environment. The individual interface corresponding to each control command has parameters for designating a target device which should execute the control command and can designate the controller control unit 302 in the same apparatus and, further, the controller control unit 302 of the image forming apparatus 200 connected by the network 1008 as targets of designation.

A job managing method which is realized in the second execution environment of the image forming apparatus by the foregoing method will now be described in detail with reference to the drawings.

FIG. 4 is a constructional diagram of the job managing application 1105 which is executed on the virtual machine 305 in FIG. 3 as a second execution environment 305 of the MFP 1102 in FIG. 1 and an information processing apparatus (computer) connected to the image forming apparatuses by the network. The job managing applications in the MFPs 1103 and 1104 are also constructed in a manner similar to the job managing application 1105. Information showing output contents such as print, copy, facsimile, and the like which is outputted by the MFP 1102 is stored and managed as a job history by the application 1105. For example, at the time of the printing process, the image data developed by the PDL developing unit 8 is printed by a printer unit including a controller for executing the printing by a laser beam printer, and in response to the end of a paper delivery, the CPU 703 is notified of completion of the paper ejection by the printer unit or a paper ejecting unit (not shown). When the notification of the completion of the paper ejection is received, the CPU collects the information of the job under processing at present as history information. The application 1105 stores it as a series of job information into the HDD 100A as an example of a storing medium of a large capacity which is built in the MFP or is externally attached. After that, a copy job, a print job, and a facsimile job are processed. In response to completion of the processes of those jobs, the job information is collected, recorded, and stored in the HDD 100A. As will be explained hereinafter, the stored job history can be outputted as a file (exported) to the designated information processing apparatus (computer). Setting regarding the output of the job history can be made in each of the job managing applications. By outputting the job history stored in each job managing application to the setting PC 1101, which will be explained hereinafter, the job histories held in a plurality of job managing applications can be collected into one job history.

Reference numeral 1101 denotes the setting PC. As mentioned above, the setting PC 1101 has a hardware construction having the PC function as shown in FIG. 2. The setting application on the information processing apparatus can make setting (output destination, schedule, transmitting method) regarding the output of the job histories which are outputted by the job managing applications. By transmitting the setting information to each job managing application, the output setting of a plurality of job managing applications can be made in a lump. The job managing applications in the MFPs 1102, 1103, and 1104 include a Web application. The job managing application 1105 can accept various operations including the output setting of the job history from the PC 1101. A job management setting application, which will be explained hereinafter, has been stored in the HD 206 in FIG. 2 and is read out therefrom, stored into the RAM 203, and executed under control of the CPU 201.

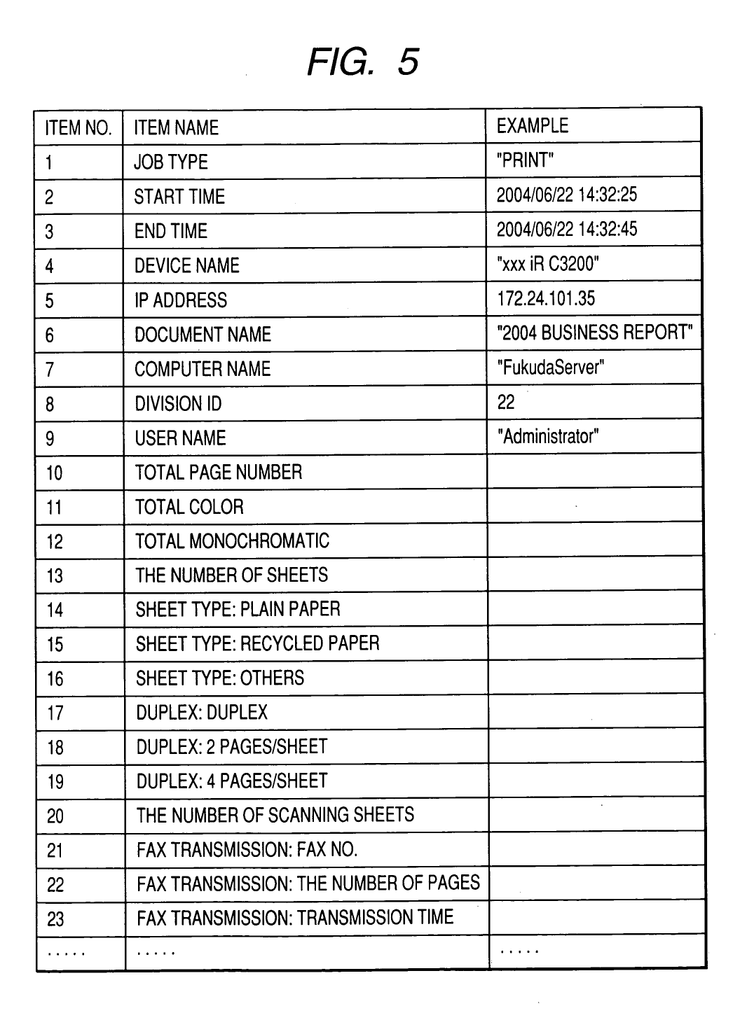

FIG. 5 is a diagram showing an example of the job history. Various kinds of information have been defined with respect to the jobs outputted to the image forming apparatus. When the job history is outputted to the image forming apparatus, an event is sent to an accounting application included in the job managing application 1105 on the image forming apparatus, and the accounting application registers and stores the information outputted to the image forming apparatus as a job history into the HDD 100A in FIG. 1. A format of FIG. 5 includes the detailed job information.

For example, the following items can be recorded: a job type such as print job, copy job, facsimile job, or the like; start time and end time of the job; a device name; an IP address; a document name as an output target; a computer name showing an outputting source of the job; a division ID serving as a charging destination which issues the job; a user name under the division; the total number of logical output pages (12); the number of physical output sheets (13); the total number of color pages included in the job; the total number of monochromatic pages; a sheet type; duplex or not; layout information indicative of 2up or the like; the number of scanning sheets; and a facsimile number, the number of pages, and transmission time as FAX transmission information. However, since a size of those information is large and they are prepared and accumulated every job, even if the memory of a large capacity such as an HDD 100A of the MFP is used, the memory is excessively consumed.

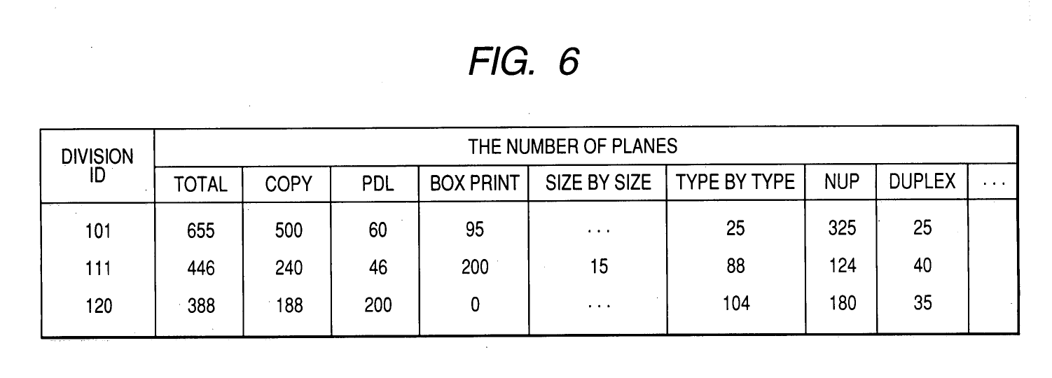

FIG. 6 shows contents of the accounting table data. This data is obtained by forming the data in a table format by collecting some information again with respect to the job information of FIG. 5 outputted to the image forming apparatus. The format of the accounting table has been predetermined and, for example, the numbers of output sheets per sheet type and sheet size are now collected and displayed. The user can confirm the information regarding only the number of output sheets by using the accounting table. The accounting table is additionally edited and held in the accounting application each time the data is outputted to the image forming apparatus. If the information which is unnecessary at present in the job information of FIG. 5 is abandoned by using the accounting table, the HDD 100A or the like is not excessively consumed.

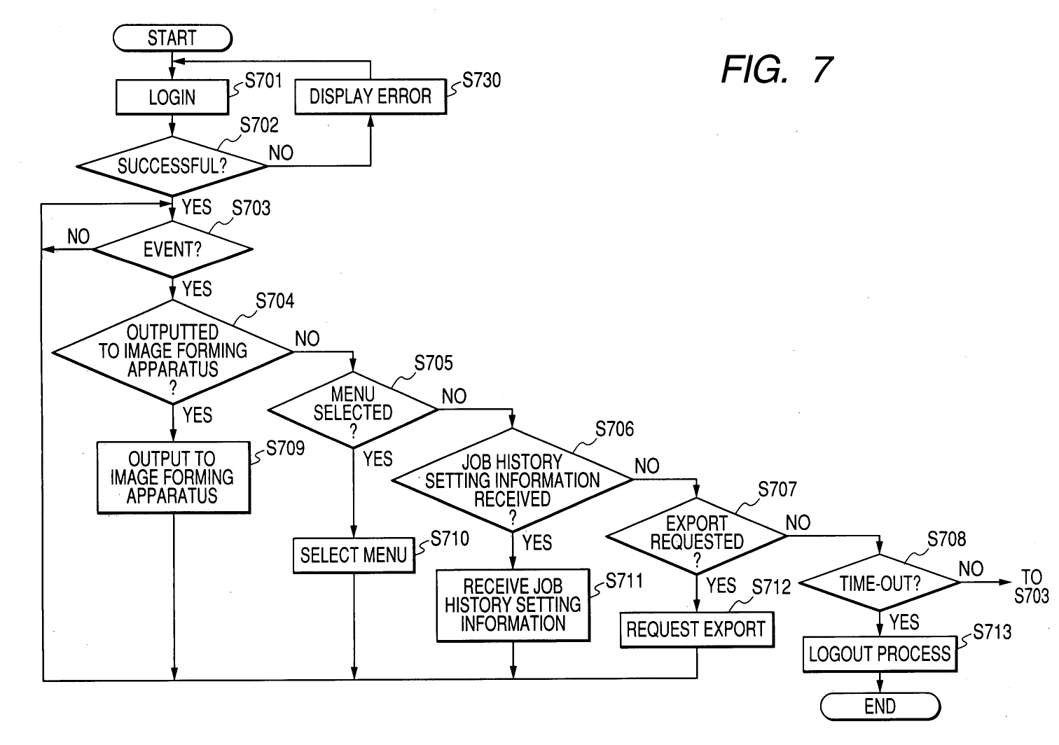

FIG. 7 is a flowchart showing processing contents of the job managing application. Each processing step is realized when the job managing application 1105 is executed by the CPU 201.

When a login request is made by the setting PC 1101, the processes of FIG. 7 are started. In step S701, reception of the login to the job managing application, that is, request of authentication information of a password and a user ID is waited. Whether or not there is an input of the authentication information from the setting PC 1101 and the authentication is permitted by the authentication information is discriminated (S702). routine advances to processes after step S703. If it is not permitted, an error is displayed in step S730.

In S703, an event is waited. If it is decided in S703 that the event has been generated, S704 follows. If the job managing application determines that the event showing the output to the image forming apparatus has been generated, S709 follows. In S709, the job information is outputted to the image forming apparatus. If it is decided in S704 that the event showing the output to the image forming apparatus is not generated, S705 follows. In S705, various processes are executed when a menu is selected by the user operation in the job managing application.

If it is decided in S705 that the menu is not selected, S706 follows. If it is decided in S706 that the event showing the reception of job history setting information has been generated, S711 follows. In S711, the output setting of the job history is made in the setting PC 1101 connected to the image forming apparatus by the network, the job histories are transmitted to the accounting application, and the setting information is received by the accounting application of the MFP side.

If it is decided in S706 that the event showing the reception of job history setting information is not generated, S707 follows and whether or not the event showing an export request has been generated is discriminated. If it is decided in S707 that the event has been generated, S712 follows. If it is decided that the event is not generated, S708 follows and whether or not a time-out event has been generated is discriminated. If it is decided in S708 that the time-out event showing the elapse of a predetermined time from the point of time when the login occurs in S701 by the time-counting of a timer is not generated, S703 follows. If it is decided in S708 that the time-out event has been generated, S713 follows, a logout process is automatically executed, and the processing routine is finished. In S712, a schedule (output date) is set in the output setting of the job history. After that, the job history is outputted in accordance with the schedule.

Each process will be described in detail hereinbelow. Each step in flowcharts is executed by the job managing application 1105.

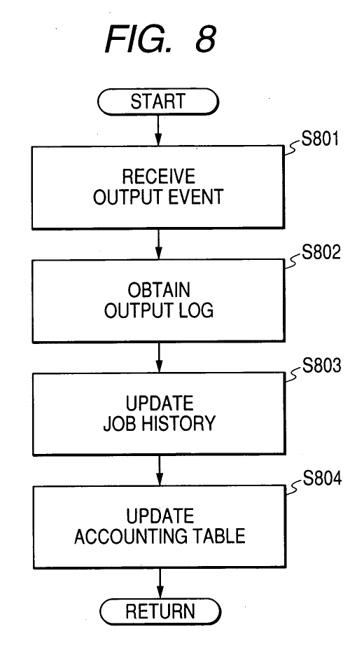

FIG. 8 shows the process of S709, that is, the process in the case where the event showing that the job information was outputted to the image forming apparatus has been generated. In S801, an output event set into a print unit accounting application is received from the CPU 703 of the MFP 1102. In S802, an output log (output information) is obtained. In S803, the job history is formed and updated by the output log obtained in S802. In S804, necessary information regarding the number of sheets is extracted from the output log obtained in S802 and added to the accounting table, and the table is edited.

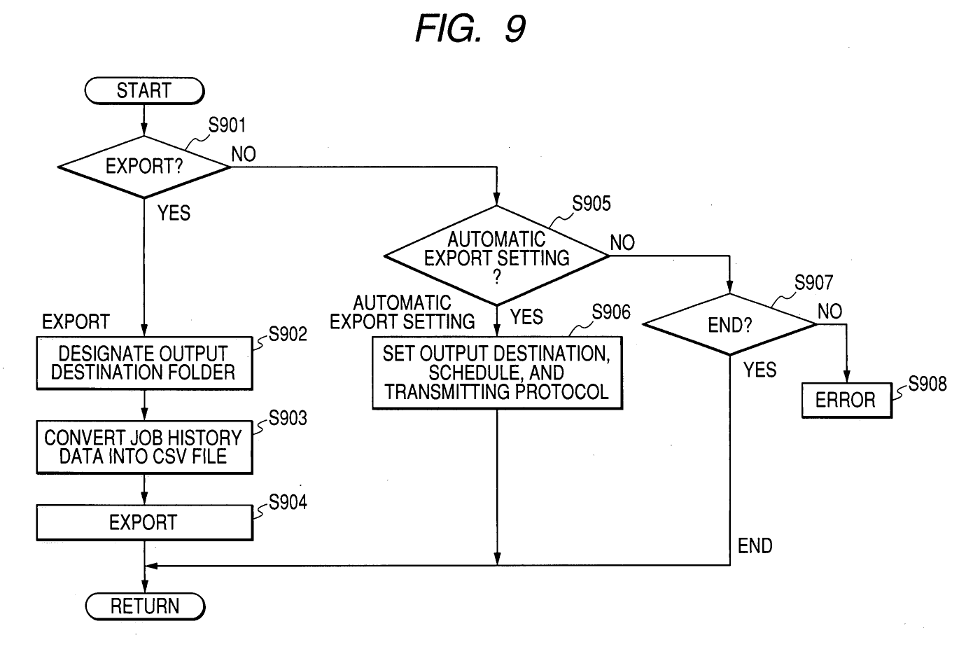

FIG. 9 shows processes which are started in the case where the accounting application detects the generation of the menu selecting event in S705. That is, FIG. 9 shows processing contents in the case where the user executes various processes by the menu selection. In S901, the user selects and indicates the menu and the accounting application recognizes the selecting instruction. It is now assumed that the user can select the export (file output) of the job history by the user operation and the output setting of the job history. S902 to S904 are processes in the case where the export of the job history by the user operation is selected. In S902, a PC and a folder of an output destination of the job history are designated. In S903, the accounting application converts the holding job history into the file. In S904, the job history converted into the file in S903 is outputted to the folder designated in S902. In S905, the output setting of the job history is made. It is possible to set the output destinations (output destination PC and output destination folder), the schedule (time and date of outputting the job history), and a transmitting method (communicating protocol of the job history, one of FTP, SMB, and E-mail is selected).

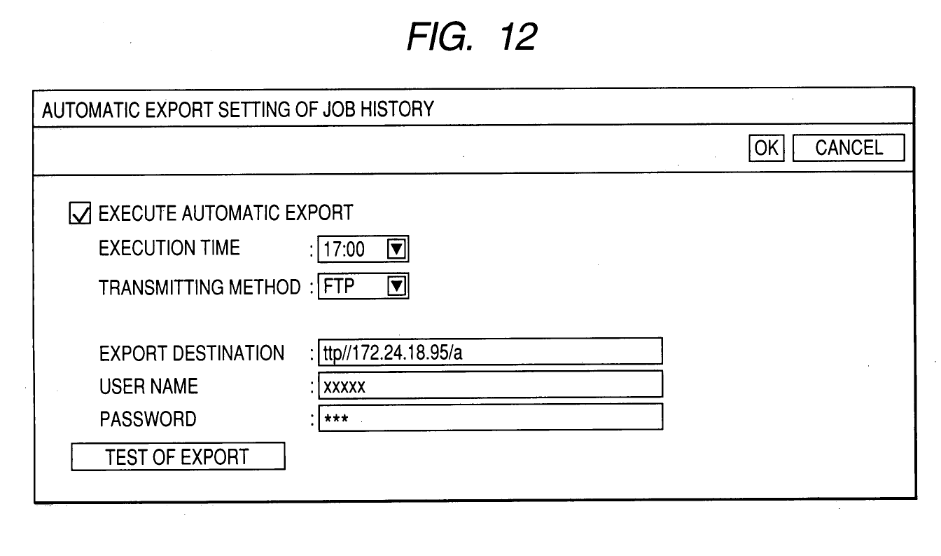

They can be set on a setting display screen of FIG. 12. Execution time (schedule), a transmitting method (protocol is selected), and an export destination (output destination) are defined as setting information of the job history. The job history is outputted as a file in accordance with the setting information. The file name has been predetermined. Since an IP address of the image forming apparatus is included in the file name, the image forming apparatus on which the job managing application which outputted the job history can be discriminated. As other items, the user name and the password are inputted for the user authentication.

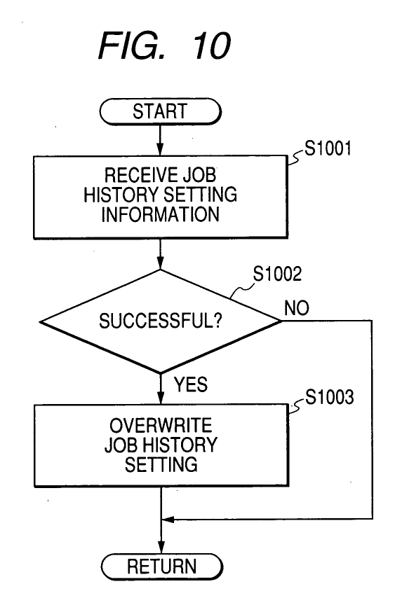

FIG. 10 shows processes in the accounting application when the accounting application receives the setting information in the case where the output setting of the job history is made and the setting information is transmitted to each job managing application in the information processing apparatus connected to the image forming apparatus through the network. In S1001, the setting information which has been set and transmitted in the setting application (1101) is received. If the setting information has successfully been received in S1002, S1003 follows. In S1003, the received job history output setting information is held. If the setting information already exists, overwriting is executed. Upon overwriting of the setting information, it is preferable that the overwriting is executed also to the information set in S905.

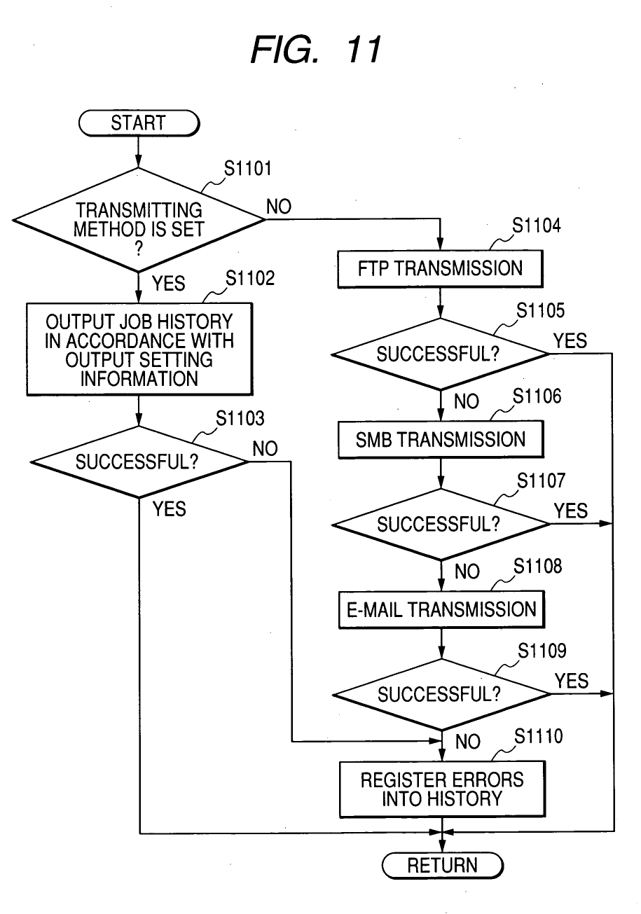

FIG. 11 shows processes which are started when the export request event, that is, the event showing that the timing reached the predetermined time as a schedule set in the job history output setting has been generated (YES in S707). In S1101, whether or not the transmitting method has been set in the job history output setting is discriminated. If the transmitting method has been set, S1102 follows and the job history is transmitted in accordance with the preset protocol. If the transmission is successful in S1103, the processing routine is finished as it is. If the transmission failed, S1110 follows, an error is recorded in the history, and the processing routine is finished. S1104 and subsequent steps are processes which are executed in the case where the transmitting method is not set. The job history is transmitted in order of the predetermined transmitting method (protocol). In S1104, the job history is transmitted by the FTP transmission. If it is determined in S1105 that the transmission is successful, the processing routine is finished. If the transmission failed, S1106 follows and the job history is transmitted by the SMB. If it is determined in S1107 that the transmission is successful, the processing routine is finished. If the transmission failed, S1108 follows and the job history is transmitted by the E-mail transmission. If it is determined in S1109 that the transmission is successful, the processing routine is finished. If the transmission failed, S1110 follows, the error is written in the history, and the processing routine is finished.

By the above processes, the job histories possessed by the job managing applications which operate on a plurality of image forming apparatuses can be collected to one location without using a server computer. By transmitting the output setting information of the job histories set in the information processing apparatus to the accounting application on the image forming apparatus and making the batch setting, ease of use of the user regarding the output setting of the job history is improved.

Although the embodiment regarding the output of the job history (job information) has been shown, accounting table data in which a part of the information of the job is held as data in a table format can be also similarly used in place of the job history.

As described above, the job managing application 1105 for managing the job information accounting table including the statistic data of the job information obtained by collecting the job information of FIG. 5 and the job information of FIG. 6 has been disclosed. Further, the job managing application 1105 obtains the output setting information which defines the outputting method of the job information from the setting PC 1101 through the network 1008 as a communicating medium. The job information can be also transmitted to the setting PC 1101, another PC 1200 except for the PC which made the setting, the MFP 1103, or the like. Further, the job managing application 1105 collects the job information as a job information accounting table by using the job information. Moreover, the job managing application 1105 controls the transmitting process in such a manner that if the job information has already been collected, it is transmitted to the external setting PC 1101 and if the job information is not collected yet, for example, in the case where it is not reflected to the job information accounting table, the job information is not outputted to the network.

In addition, as for the output setting information, it is sufficient that either the time information indicative of the time when the transmitting means transmits the job information or at least one of the transmitting protocols (FTP, SMB, SMTP, etc.) which are used for the transmission by the job managing application 1105 can be defined as an outputting method. In the setting PC 1101 which manages the job information which is stored in the MFPs 1102 to 1104 for managing the job information accounting table and the job information, the job management setting application which manages the job information as defined output setting information in which the outputting method of the job information including the time information indicative of the outputting time of the job information or the information indicative of the output destination to which the job information is outputted has been disclosed. The output setting information which is managed by the job management setting application is transmitted to a plurality of MFPs 1102 to 1104.

Further, it is preferable if the apparatus of the output destination which is set as output setting information is regarded to be identical and set to the MFPs 1102 to 1104. For example, if the job information is outputted to the setting PC 1101 just at 23 o'clock every night and the job information is deleted on the side of the MFPs 1102 to 1104, the job information is stored and held in the setting PC 1101, the area such as an HDD 100A or the like used by the job information stored in the MFPs 1102 to 1104 is released and used for another object, and the necessary information can be provided by using the job information accounting table.

If the job information is collected to one setting PC by the embodiment of the invention, since there is no need to prepare a server for the job management, the operation costs can be reduced. That is, even in the image forming apparatus which can download the job managing module into an execution environment different from the control of the image forming apparatus and execute it, since each image forming apparatus holds the job information of each image forming apparatus, in order to make the job management of all of a plurality of image forming apparatuses and collect the job information to one location, the job management of all of a plurality of image forming apparatuses can be made by one PC without needing to prepare the server for collecting the job information of all of the image forming apparatuses in the use environment of the user.

According to another aspect of the invention, in the case of making the setting of outputting the job history outputted to each image forming apparatus, there is no need to make the setting to the execution environments constructed on each image forming apparatus one by one.

Further, according to further another aspect of the invention, even if the server to collect the job information is not prepared, the job histories outputted to a plurality of image forming apparatuses can be also collected. In an information processing apparatus different from the image forming apparatus, by making the output setting of the job history and transmitting the output setting file, the output setting of the job histories outputted to a plurality of image forming apparatuses can be set in a lump. When the job collection as detailed information is needed while raising a memory efficiency of the image forming apparatuses, there is such an effect that the detailed information included in the job information can be collected in an on-demand manner.

The processes shown in FIGS. 7 to 11 in the embodiment are executed by the MFP 1102 or setting PC 1101 by programs which are installed from the outside. In this case, the invention is also applied to the case where an information group including the programs is supplied to a host computer by a storing medium such as CD-ROM, flash memory, FD, or the like or from an external storing medium through the network.

As described above, naturally, the object of the invention is also accomplished by a method whereby the storing medium on which program codes of software for realizing the functions of the embodiments mentioned above have been recorded is supplied to a system or an apparatus and downloaded from another PC, so that a computer (or a CPU or an MPU) of the system or the apparatus reads out the program codes stored in the storing medium, and executes them.

In this case, the program codes themselves read out from the storing medium realize the novel functions of the invention. The storing medium on which the program codes have been stored constructs the invention. For example, a floppy disk, a hard disk, an optical disk, a magnetooptic disk, DVD, CD-ROM, magnetic tape, nonvolatile memory card, ROM, EEPROM, or the like can be also used as a storing medium to supply the program codes.

Naturally, the invention incorporates not only the case where a computer executes the read-out program codes, so that the functions of the embodiments as mentioned above are realized but also the case where the OS (Operating System) or the like which is operating on the computer executes a part or all of actual processes on the basis of instructions of the program codes and the functions of the embodiments as mentioned above are realized by those processes. Further, naturally, the invention also incorporates the case where the program codes read out from the storing medium are written into a memory provided for a function expanding board inserted in the computer or a function expanding unit connected to the computer, after that, a CPU or the like provided for the function expanding board or the function expanding unit executes a part or all of the actual processes on the basis of the instructions of the program codes and the functions of the embodiments as mentioned above are realized by those processes.

As many apparently widely different embodiments of the present invention can be made without departing from the spirit and scope thereof, it is to be understood that the invention is not limited to the specific embodiments thereof except as defined in the claims.

This application claims priority from Japanese Patent Application No. 2004-210112 filed Jul. 16, 2004, which is hereby incorporated by reference herein.

What is claimed is:

1. An image forming apparatus comprising:
a managing unit adapted to manage job information and a job information accounting table including statistic data of job information obtained by collecting the job information;
an obtaining unit adapted to obtain output setting information which defines an outputting method of the job information from an external information processing apparatus through a communicating medium; and
a transmitting unit adapted to transmit the job information to the external information processing apparatus or another information processing apparatus in accordance with the output setting information obtained by said obtaining unit.

2. An apparatus according to claim 1, further comprising:
a collecting unit adapted to collect the job information as a job information accounting table by using the job information;
a recognizing unit adapted to recognize whether or not the job information has already been collected as a job information accounting table by said collecting unit; and
a transmitting unit adapted to transmit the job information recognized by said recognizing unit that the job information has already been collected as a job information accounting table and not transmit the job information recognized by said recognizing unit that the job information is not collected yet.

3. An apparatus according to claim 1, wherein as the output setting information, either time information indicative of time when said transmitting unit transmits the job information or at least one of transmitting protocols which are used for the transmission by said transmitting unit can be defined as the outputting method.

4. A job information processing method comprising:
managing job information and a job information accounting table including statistic data of job information obtained by collecting the job information;
obtaining output setting information which defines an outputting method of the job information from an external information processing apparatus through a communicating medium; and
transmitting the job information to the external information processing apparatus or another information processing apparatus in accordance with the output setting information obtained in said obtaining step.

5. A method according to claim 4, further comprising:
collecting the job information as a job information accounting table by using the job information;
recognizing whether or not the job information has already been collected as a job information accounting table in said collecting step; and
transmitting the job information recognized in said recognizing step that the job information has already been collected as a job information accounting table and not transmitting the job information recognized in said recognizing step that the job information is not collected yet.

6. A method according to claim 4, wherein as the output setting information, either time information indicative of time when the job information is transmitted in said transmitting step or at least one of transmitting protocols which are used for the transmission in said transmitting step can be defined as the outputting method.

7. A control program stored on a computer-readable storage medium such that, when executed by a computer, the program causes the computer to execute a job information processing method comprising:
managing job information and a job information accounting table including statistic data of job information obtained by collecting the job information;
obtaining output setting information which defines an outputting method of the job information from an external information processing apparatus through a communicating medium; and
transmitting the job information to the external information processing apparatus or another information processing apparatus in accordance with the output setting information obtained in said obtaining step.

8. A job managing apparatus for managing job information stored in an image forming apparatus which manages a job information accounting table and the job information, comprising:
a managing unit adapted to manage output setting information that defines an outputting method of the job information, the output setting information including time information indicative of time when said image forming apparatus outputs the job information or destination information indicative of an output destination to which said image forming apparatus outputs the job information; and
a transmitting unit adapted to transmit the output setting information managed by said managing unit to a plurality of image forming apparatuses.

9. An apparatus according to claim 8, wherein a same apparatus is set as the output destination designated in the output setting information managed by said managing unit for the plurality of image forming apparatuses.

10. A job managing method of managing job information stored in an image forming apparatus which manages a job information accounting table and the job information, comprising:
managing output setting information that defines an outputting method of the job information, the output setting information including time information indicative of time when the image forming apparatus outputs the job information or destination information indicative of an output destination to which the image forming apparatus outputs the job information; and
transmitting the output setting information managed in said managing step to a plurality of image forming apparatuses.

11. A method according to claim 10, wherein a same apparatus is set as the output destination designated in the output setting information managed in said managing step for the plurality of image forming apparatuses.

12. A control program stored on a computer-readable storage medium such that when executed by a computer, the program causes the computer to execute a job managing method of managing job information stored in an image forming apparatus which manages a job information accounting table and the job information, wherein the method comprises:
managing output setting information that defines an outputting method of the job information, the output setting information including time information indicative of time when the image forming apparatus outputs the job information or destination information indicative of an output destination to which the image forming apparatus outputs the job information; and
transmitting the output setting information managed in said managing step to a plurality of image forming apparatuses.
